(19) United States
(12) Patent Application Publication
(10) Pub. No.: US 2006/0053399 A1
(43) Pub. Date: Mar. 9, 2006

(54) Semiconductor device, designing device, layout designing method, program and storage medium

(75) Inventors: Hiroyuki Honda, Kawasaki (JP); Toshio Arakawa, Kawasaki (JP); Hiroshi Mawatari, Kawasaki (JP); Norito Hibino, Kawasaki (JP); Kouji Arai, Kawasaki (JP); Keigo Tada, Kawasaki (JP); Fukuji Kihara, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 11/014,843

(22) Filed: Dec. 20, 2004

(30) Foreign Application Priority Data
Sep. 6, 2004 (JP) 2004-258742

(51) Int. Cl. G06F 17/50; G06F 9/455

(52) U.S. Cl. 716/11

(57) ABSTRACT

A designing device for designing a layout of a semiconductor device includes a layout position candidate extracting unit for obtaining layout position candidates of a regulator, a tentatively wiring unit for tentatively arranging the regulator at the layout position candidates and tentatively laying out a power line, and a regulator layout position deciding unit for deciding a position of a tentative layout at which an area of the power line that is tentatively laid out is the smallest as the layout position of the regulator.

### CROSS-REFERENCE TO RELATED APPLICATIONS

This application is based upon and claims the benefit of priority from the prior Japanese Patent Application No. 2004-258742, filed in Sep. 6, 2004, the entire contents of which are incorporated herein by reference.

### BACKGROUND OF THE INVENTION

1. Field of the Invention

The present invention relates to a semiconductor device and a technique of designing the semiconductor device, and more particularly to a layout design of an integrated circuit.

2. Description of the Related Art

Generally, in a layout design of a semiconductor device such as an integrated circuit, a power line is laid out by automatic processing using a designing device or manually by a designer.

In the layout design, there is the possibility that IR drop occurs depending on a position at which hard macro is arranged, and the performance of the device is deteriorated. In order to cope with this problem, there is adopted an approach of ensuring a sufficiently large wiring width of the power line extending to the hard macro or the like.

For example, JP 7-235600A (paragraphs [0017] to [0018] and [0042]) discloses that the width of the power line is made larger than a reference wiring width in order to cope with a voltage drop at the power line extending to a clock driver cell.

It is necessary to increase the width of the power line with respect to a portion such as the hard macro, into which a large current flows. However, when the width of the power line is merely increased as described above, the area is occupied by the wiring as much. This leads to such a disadvantage that a chip size becomes large.

The above problem remarkably occurs in a device having a difference between an external voltage of the device and an internal voltage within the device and mounting a step-up circuit and a step-down circuit (hereinafter referred to as “regulator”) for stepping down or up a voltage in order to convert the external voltage into the internal voltage. This is because an output of the regulator is a provider of the internal power supply to the hard macro or the like.

### SUMMARY OF THE INVENTION

The present invention has been made in view of the above circumstances, and therefore an object of the present invention is to provide a semiconductor device that prevents a chip size from increasing due to an excessive influence of a power line, and reduces the chip area, and a designing device, a layout designing method, program and a storage medium which are capable of reducing the chip size.

The designing device according to the present invention conducts a layout design of the semiconductor device and includes a layout position candidate extraction unit, a tentatively wiring unit, and a regulator layout position decision unit in order to solve the above problem.

The layout position candidate extraction unit obtains a layout position candidate of the regulator.

The regulator is tentatively disposed at the layout position candidate, and the power line is tentatively laid out.

The regulator layout position decision unit decides a tentative layout position that is the smallest in an area of the power line that has been tentatively laid out as the regulator layout position.

Since the above construction makes it possible to arrange the regulator at an optimized position, the area required for the power line can be reduced.

Also, a designing device according to another embodiment of the present invention includes a layout position candidate extraction unit that obtains the layout position candidate of the regulator, a tentatively wiring unit that tentatively arranges a plurality of regulators at the layout position candidate and tentatively lays out the power line, and a layout position decision unit that decides a tentative layout position that is the smallest in an area of the power line that has been tentatively laid out as the regulator layout position.

The above construction makes it possible to divide the regulator into a plurality of regulators and arrange the regulators at the optimized positions.

Also, the semiconductor device according to the present invention includes a power supply terminal, a circuit block whose layout has been designed by the hard macro, and a regulator that is disposed in the vicinity of the power supply terminal and the circuit block.

The above construction makes it possible to shorten the power line that is laid out between the hard macro and the regulator and also to reduce the chip size.

In addition, the present invention encompasses the layout designing method of the semiconductor device, the program and a portable storage medium.

According to the present invention, since the number of regulators and the regulator layout position can be optimized, the chip size can be reduced.

Also, an improvement in the electric characteristic due to the prevention of IR drop can be expected.

### BRIEF DESCRIPTION OF THE DRAWINGS

These and other objects, features and advantages of the present invention will become more apparent upon consideration of the following description of the preferred embodiments of the present invention taken in conjunction with the accompanying drawings.

FIG. 1 is a flowchart showing a flow of a general layout design;

FIG. 2 is a flowchart showing the outline of a layout design process that is made by the designing device according to an embodiment of the present invention;

FIG. 3 is a diagram showing the concept of a method according to a first embodiment of the present invention;

FIGS. 4 and 5 are flowcharts showing a specific process that is made by the designing device according to the first embodiment;

FIG. 6 is a flowchart showing a process that is conducted by the designing device of the first embodiment at the time of designing the layout;

FIG. 7 is a diagram showing the concept of a method according to a second embodiment of the present invention;

FIG. 8 is a diagram showing a specific procedure according to the second embodiment;

FIG. 9 is a flowchart showing a process that is conducted by the designing device of the second embodiment at the time of designing the layout;

FIG. 10 is a diagram showing a structural example of a designing device that designs a layout of a semiconductor circuit; and

FIG. 11 is a diagram showing an example of a storage medium.

### DETAILED DESCRIPTION OF THE PREFERRED EMBODIMENTS

Now, a description will be given in more detail of a preferred embodiment of the present invention with reference to the accompanying drawings.

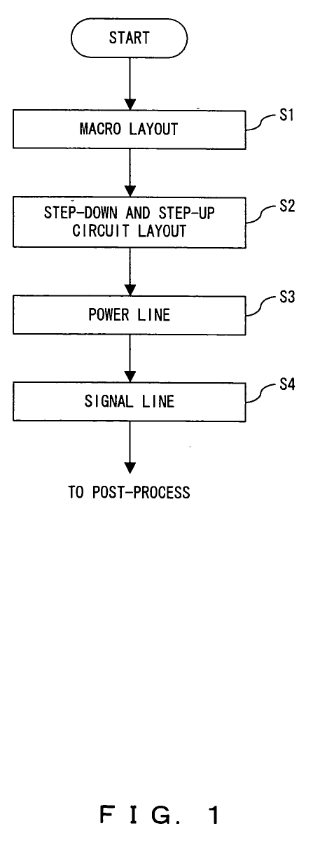

FIG. 1 is a flowchart showing a flow of a general layout design.

Referring to FIG. 1, a hard macro is laid out in Step S1, a step-down circuit and a step-up circuit (regulator) is laid out in Step S2, a power line is wired in Step S3, and a signal line is finally wired in Step S4.

In this embodiment, in the above flow, attention is paid to the regulator layout position, and in conducting the layout design, the power line and the signal line are laid out after the regulator has been arranged at the obtained regulator layout position at which the chip size becomes the smallest. Also, the power line extending up to the hard macro that is large in power consumption is widened and the power line from the hard macro is narrowed.

The hard macro is one sort of function block that realizes a predetermined function by combination of a plurality of basic circuits, and supplied to a designer by the designing device as a library. The hard macro cannot conduct a change, deletion and movement of the configuration, internal basic circuits and wirings that connect those internal basic circuits to each other. However, the hard macro clarifies a signal timing, the size and the power consumption. The circuit supplied as the hard macro may be general memory circuits such as a ROM or a RAM, an analog circuit such as a PLL, an A/D or a D/A, or a digital circuit such as a CPU or a CR input/output circuit which requires a severe timing.

The circuit block that is made up of those hard micros is generally large in the power consumption, and the power consumption is known in advance.

In this embodiment, in decision of the regulator layout position in Step S2, the power line to be wired which extends from the regulator to the circuit block made up of the hard macros is shortened as much as possible, thereby reducing the area. More specifically, the regulator is arranged at a location that is in the vicinity of a power terminal which is an external lead electrode pattern and has a short distance to the circuit block made up of the hard macros. Then, the power line that extends from the regulator to the circuit block made up of the hard macros is appropriately widened, and the power line that extends from the hard macros is narrowed.

With the above construction, since the area required for the power line is reduced more than that in the layout design using the conventional manner, the chip size can be reduced as much.

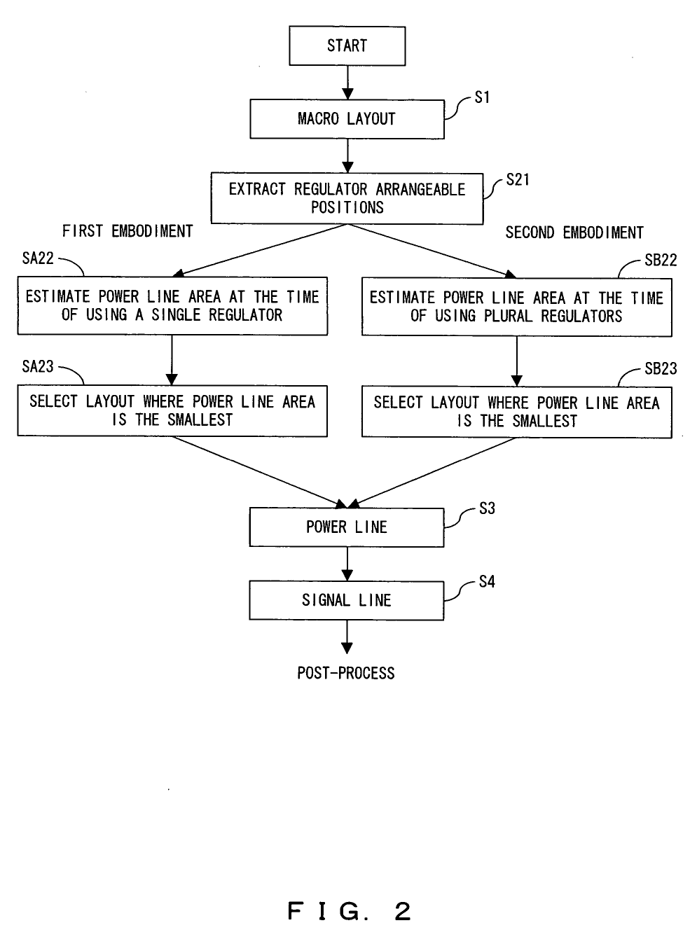

FIG. 2 is a flowchart showing the outline of a layout design process that is made by the designing device according to this embodiment of the present invention.

In the layout design process by the designing device according to this embodiment, as in the conventional manner shown in FIG. 1, after the hard macro layout position has been decided in Step S1, the regulator layout position is decided, and the power line is wired in Step S3. Finally, the signal line is wired in Step S4. In decision of the regulator layout position, the regulator layout position is decided at a position where the total wiring region (area) becomes the smallest, for example, a position that is in the vicinity of the power terminal and has a short distance to the circuit block made up of the hard macros, that is, is shorter in the length of the wiring that extends up to the circuit block made up of the hard macros.

This processing is conducted at processes of Steps S21 to S23 (SA23, SB23) in FIG. 2. In the figure, Steps SA22 to SA23 are processes that are conducted in a first embodiment, and Steps SB22 to SB23 are processes that are conducted in a second embodiment.

In the first embodiment, a power line area when one regulator is arranged in the circuit is obtained in Step SA22, and the regulator layout where the power line area becomes the smallest is selected in Step SA23.

Then, the power line is laid out on the basis of the arranged regulator position in Step S3, and the signal line is laid out in Step S4.

Also, in the second embodiment, the regulator is divided into a plurality of regulators and arranged to reduce the area, and the layout position candidates of the plurality of regulators are extracted in Step S21. Thereafter, the area of the power lines when the plurality of regulators are laid out in the circuit is obtained in Step SB22, and the layout of the regulators at which the area of the power lines becomes the smallest is selected in Step SB23.

Subsequently, a method of the first embodiment will be described in more detail.

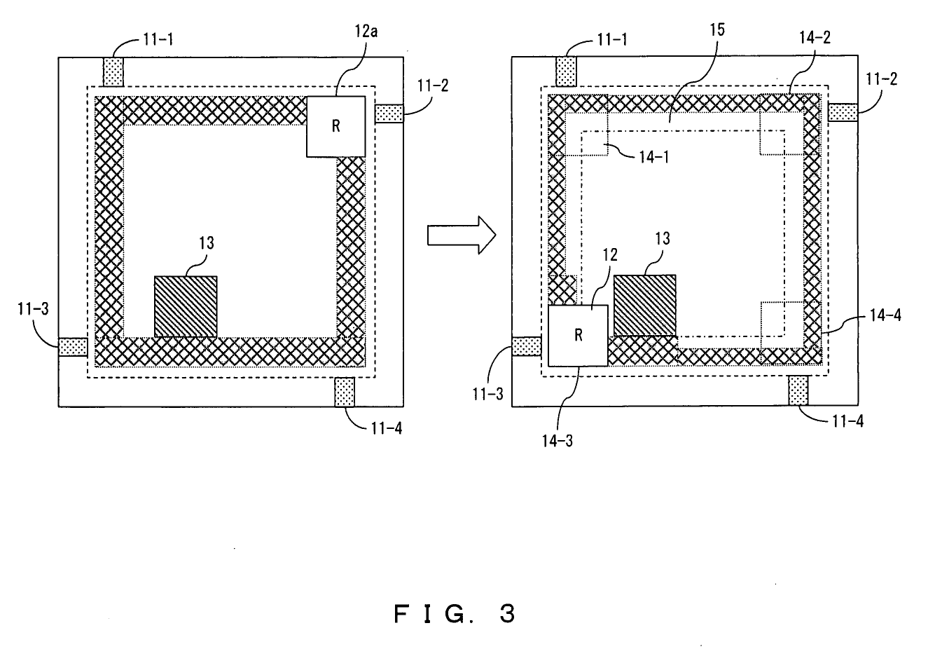

FIG. 3 is a diagram showing the concept of a method according to the first embodiment. A left drawing of FIG. 3 shows a case in which the power line is laid out after the regulator is arranged not taking the position of the circuit block made up of the hard micros into consideration as in the conventional method. A right drawing of FIG. 3 shows a case in which the power line is laid out after an appropriate regulator layout position is obtained taking the position of the circuit block made up of the hard micros into consideration according to the method of the first embodiment.

In the first embodiment, positions that have a short distance to the circuit block made up of hard macros and can reduce an area occupied by the power line are obtained from layout positions that are in the vicinity of the power terminal, and the regulator is selectively arranged at any one of the positions thus obtained.

In FIG. 3, four power terminals 11-1 to 11-4 are disposed on a chip, and four portions that are in the vicinity of those power terminals are layout position candidates, 14-1 to 14-4 of the regulator 12. A position at which an area occupied by the power line becomes the smallest among the layout position candidates 14-1 to 14-4 of the regulator 12, that is, the candidate 14-3 that is in the vicinity of a macro 13 is selected for arranging the regulator.

As a result, the area required for the power line can be reduced by a portion 15 surrounded by a dotted line as compared with the case of the left drawing in which the regulator 12 is arranged not taking the positional relationship with the hard macro 13 into consideration.

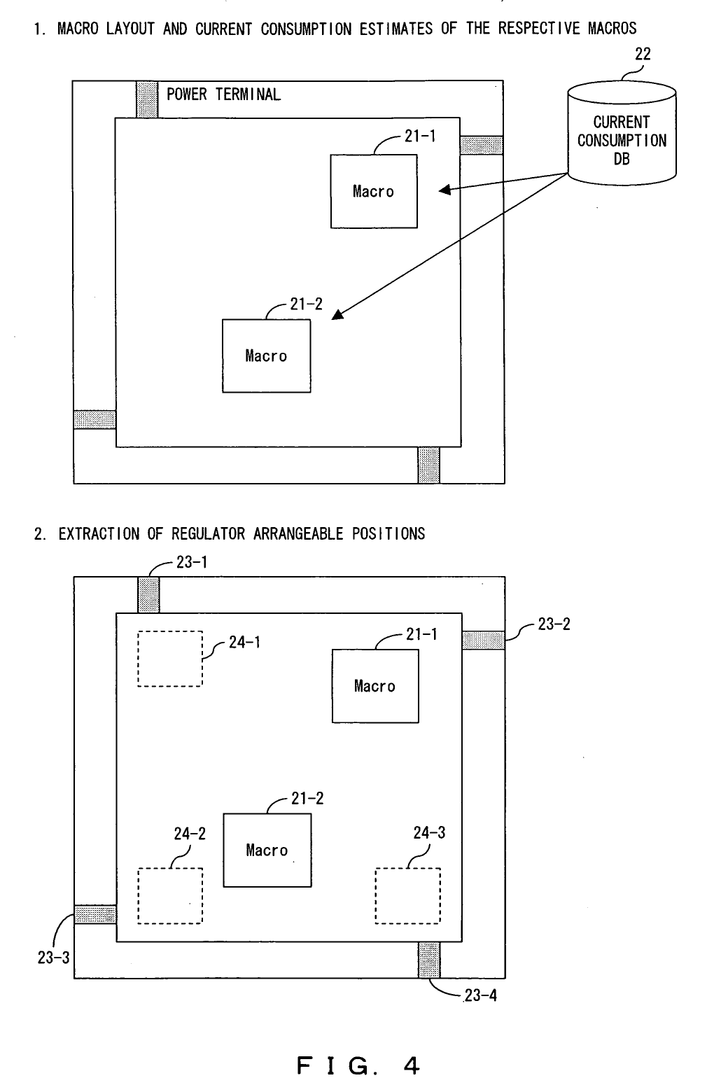

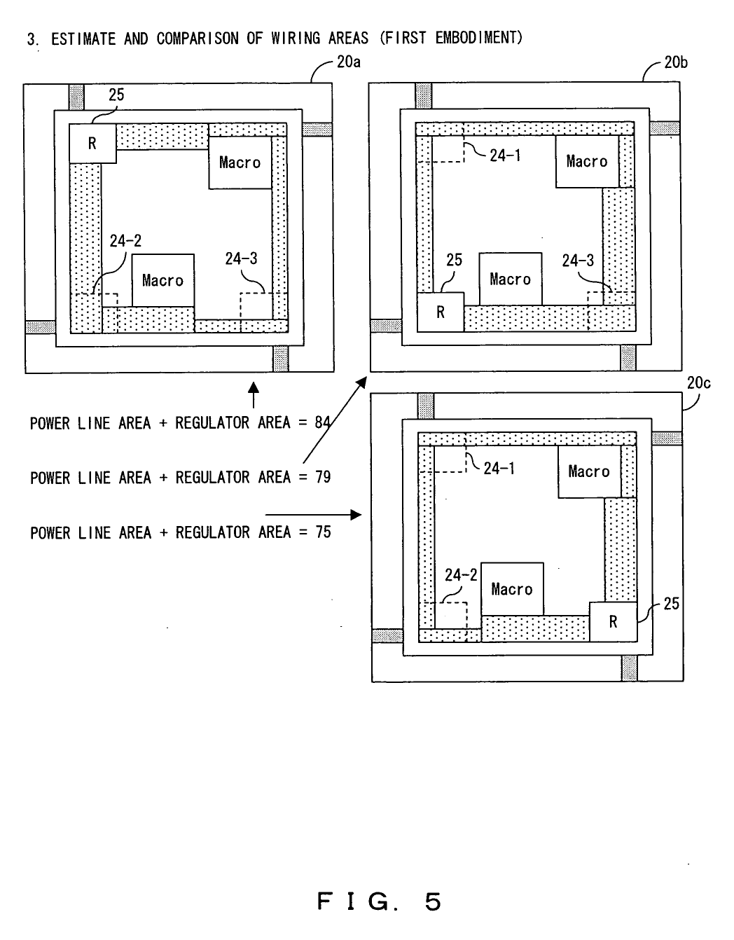

Then, a specific procedure according to the first embodiment will be described in more detail with reference to FIGS. 4 and 5.

1. Macro Layout

In the first embodiment, the layout position of the hard macro is first decided.

A circuit constituted by the hard macro is generally large in the power consumption, and its power consumption is known in advance. Therefore, in designing the layout, the designing device allows a designer to first arrange a hard macro that is large in the occupied area and has a configuration determined and to obtain a current consumption of the hard macro thus arranged with reference to a current consumption data base 22 in which the power consumptions of respective circuit elements are recorded.

In FIG. 4, there are arranged two hard macros 21-1 and 22-2 that are large in the current consumption.

The layout of the hard macros may be automatically conducted by the designing device.

2. Extraction of Regulator Arrangeable Positions

After the designer arranges the hard macro 21, the designing device obtains a regulator arrangeable position according to the layout of the hard macro 21 and a performance required for the regulator.

In the first embodiment, the size of the chip is reduced by finding a position of the regulator at which a distance of the power line that supplies an electric power to a circuit made up of the hard macro from the regulator is as short as possible. For that reason, the power consumption of the chip is first obtained, and the regulator to be used is decided according to the required performance of the regulator which is obtained from the power consumption. Then, a portion having a space in which the regulator can be arranged in the vicinity of the power terminal 23 is extracted as a regulator layout position candidate 24.

In FIG. 4, three position candidates 24-1 to 24-3 at which the regulator can be arranged are extracted as the layout position candidates of the regulator among portions that are in the vicinity of four power terminals 23-1 to 23-4.

3. Estimate and Comparison of Wiring Area

The regulator is tentatively arranged in order at the layout position candidates 24 that have been extracted in the above item 2, and the area of the power line at the respective positions is obtained. Then, the areas required for the power line at the respective layout positions are compared with each other, and the layout position candidate 24 at which the area of the power line is the smallest is selected as the layout position of the regulator.

In FIG. 5, the areas required for the respective power lines are obtained with respect to chips 20a, 20b and 20c in which the regulators are tentatively arranged in the respective layout position candidates 24-1 to 24-3, and the power lines are laid out. As a result, since the chip 20c in which the regulator 25 is arranged at the layout position candidate 24-3 is the smallest in the wiring area of the power line, the layout position candidate 24-3 is decided as the layout position of the regulator.

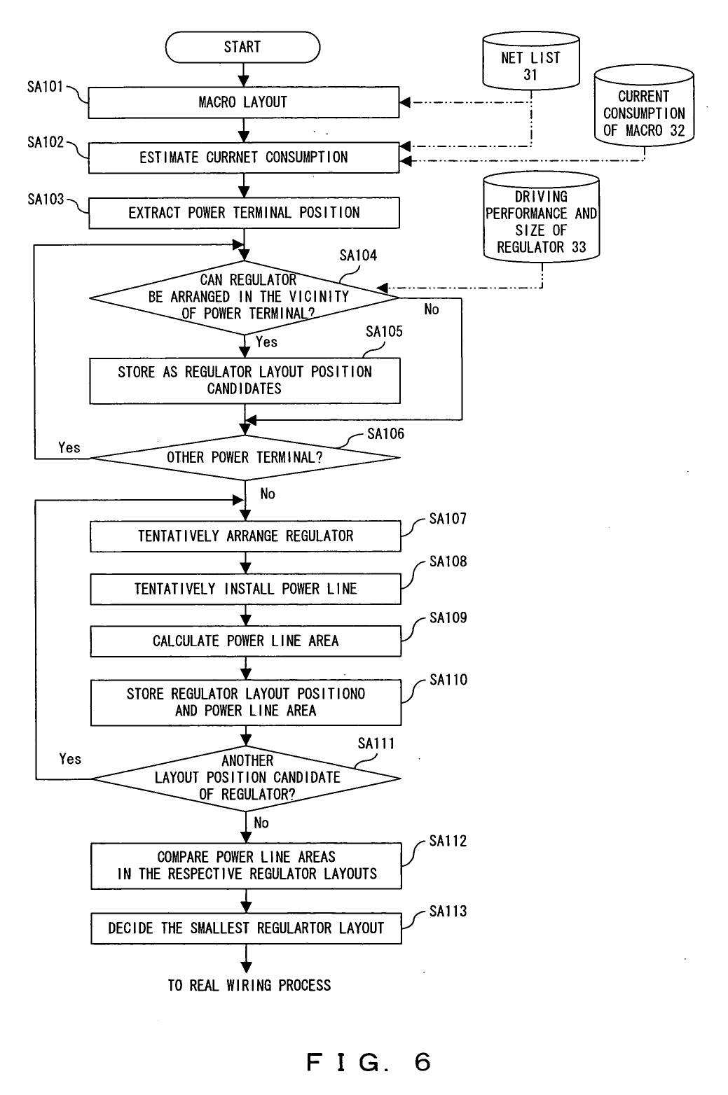

FIG. 6 is a flowchart showing a process that is conducted by the designing device of the first embodiment at the time of designing the layout.

In the figure, when the layout designing process starts, a hard macro is first arranged on a chip in Step SA101. In the arranging method, the designer may designate the layout position, or the designing device may automatically arrange the hard macro at an appropriate position on the basis of a net list 31 in which connection information of the respective circuit elements is stored.

The designing device then obtains the current consumptions of the respective hard macros and the entire current consumption thereof on the basis of the net list 31 and the current consumption information 32 of the hard macro that are stored in advance in Step SA102. Then, the designing device obtains the required performance of the regulator according to the power consumption thus obtained.

Then, the designing device extracts the candidate of the layout position of the regulator.

To achieve the above operation, the designing device first extracts the position of the power terminal in Step SA103. Then, the designing device selects one of the power terminals that have been extracted in Step SA103, and judges whether the regulator can be arranged in the vicinity of the power terminal, or not, in Step SA104, using information 33 on the driving performance and the size of the regulator which have been stored in a memory of the designing device in advance on the basis of the performance of the arranged regulator which is obtained in Step SA103.

As a result, if the regulator can be arranged (Yes in Step SA104), a position that is in the vicinity of the power terminal is stored in the memory as the layout position candidate of the regulator in Step SA105. On the contrary, if the regulator cannot be arranged in Step SA104 (No in Step SA104), the processing is skipped to Step SA106.

In Step SA106, it is judged whether there is a power terminal that is not subjected to the judgment of Step SA104 among the power terminals that have been extracted in Step SA103, or not. If there is a power terminal that has not yet been subjected to the judgment (Yes in Step SA106), the processing is shifted to Step SA104. Thereafter, the processing of Steps SA104 to SA106 is repeated, and conducted on all of the power terminals that have been extracted in Step SA103. After the processing has been conducted on all of the terminals (No in Step SA106), the processing is shifted to Step SA107.

Upon completion of the extraction of the regulator layout position candidates, the designing device then obtains the areas when the regulator is arranged at the respective layout position candidates.

The designing device tentatively arranges in Step SA107 the regulator at one of the layout position candidates that are stored in Step SA105, and tentatively lays out the power line at this tentative layout in Step SA108.

Then, the designing device calculates in SA109 the area of the power line that is tentatively laid out in Step SA108, and then stores the position of the tentative layout of the regulator and the area of the power line at that tentative layout position in the memory in Step SA110.

The processing in Steps SA107 to SA110 is conducted on all of the regulator layout position candidates that are stored in Step SA105 (Yes in Step SA111), and the wiring areas of the power line in the case where the regulator is tentatively located are stored by conducting the processing Steps SA107 to SA110 on all of the layout position candidates (No in Step SA111). Then, the wiring areas of the power line at the respective layouts of the regulator which are stored in Step SA110 are compared with each other in Step SA112. The layout position at which the area of the power line is the smallest is decided as the layout position of the regulator in Step SA113, and the processing is shifted to a real wiring process.

As described above, in the first embodiment, since the regulator can be arranged at the layout position where the area required for the power line is the smallest, the chip size per se can be suppressed to be small.

Subsequently, a method according to a second embodiment of the present invention will be described in more detail.

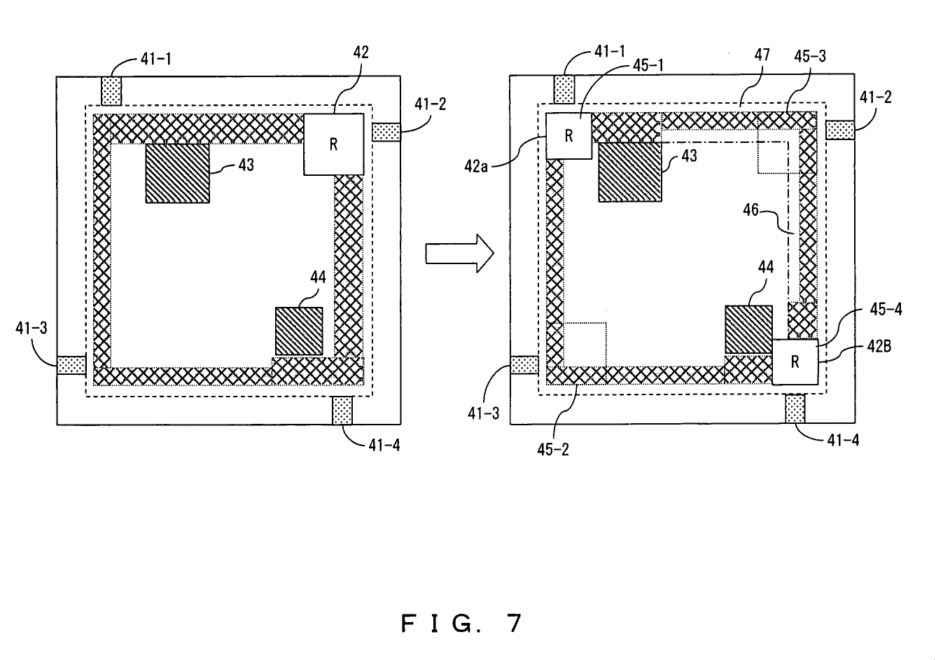

FIG. 7 is a diagram showing the concept of a method according to the second embodiment. A left drawing of FIG. 7 shows a case in which one regulator is arranged not taking the position of the circuit block made up of the hard micros into consideration. A right drawing of FIG. 7 shows a case in which the regulator is divided into a plurality of regulators, and the layout positions of the respective regulators are obtained for arranging the respective regulators, taking the position of the circuit block made up of the hard micros into consideration according to the method of the second embodiment.

In the second embodiment, a layout position which is in the vicinity of the power terminal 41 and has a short distance to the circuit block made up of the hard macros so as to suppress the area taken for the power line is obtained for arranging the regulator thereat as in the first embodiment. In decision of the layout position of the regulator at which the area of the power line becomes small, the layout position candidates are obtained taking a case in which the regulator is divided into a plurality of regulators and arranged into consideration. Then, in the case where (area of one regulator+wiring area)>(total areas of plural regulators+wiring area), the regulator is divided into a plurality of regulators and arranged, thereby reducing the chip size.

The method of the second embodiment is effective particularly in a case in which there are a plurality of hard macros large in the current consumption.

In FIG. 7, two hard micros 43 and 44 that are in the current consumption are arranged. Even in this case, four portions that are in the vicinity of the four power terminals 41-1 to 41-4 become the layout position candidates 45-1 to 45-4 of the regulator 42. The regulator 42 is divided into two regulators 42a and 42b and arranged at positions where the area occupied by the power line is the smallest in the layout position candidates 45-1 to 45-4, that is, the layout position candidates 45-1 and 45-4 in the vicinity of the macros 43 and 44.

As a result, the area required for the power line can be reduced by portions 46 and 47 surrounded by dotted lines as compared with the case of the left drawing in which the regulator 42 is arranged not taking the positional relationship with the hard macro 43 into consideration. Also, the area required for the power line can be reduced by the portion 46 surrounded by the dotted line as compared with the case in which one regulator is arranged at the position 45-1 as in the first embodiment.

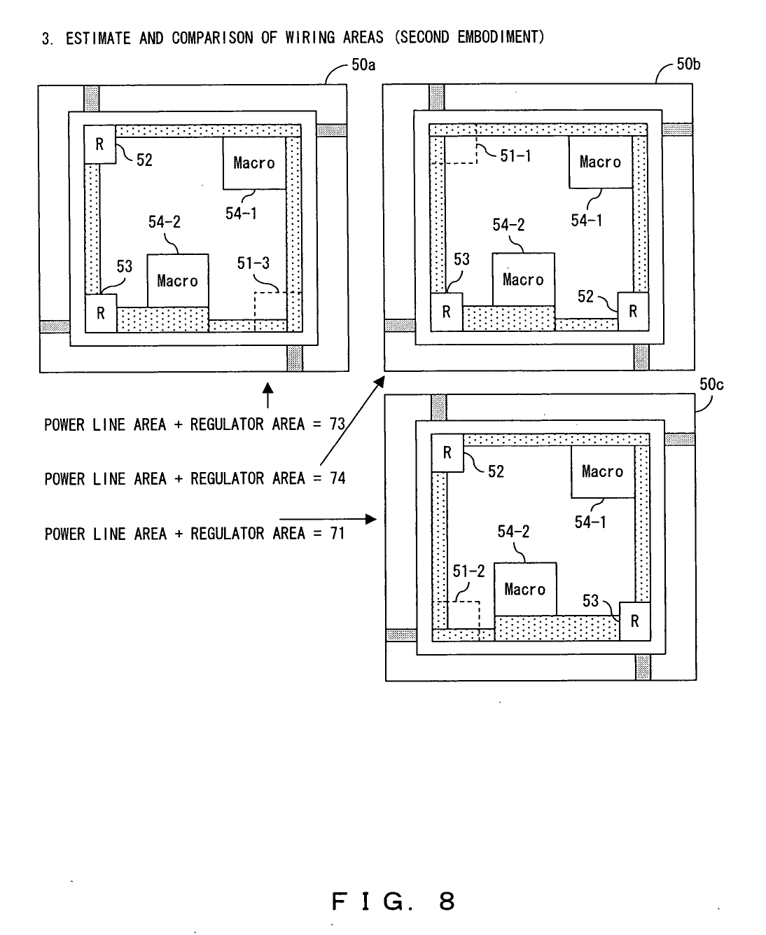

Then, an example of a specific arranging process according to the second embodiment will be described with reference to FIG. 8.

In the second embodiment, the regulator arrangeable position is extracted after the hard macros are arranged and the current consumptions of the respective hard macros are estimated as in the first embodiment. This process is substantially identical with the process shown in FIG. 4 except that the performance of the regulator and the area required for the layout are different when the regulator arrangeable position is extracted. In this situation, even in the case where only one regulator arrangeable position is found, the same process as that in the first embodiment is basically executed.

FIG. 8 shows an estimate of the wiring area when the regulator is tentatively arranged in the second embodiment and its comparing process, which corresponds to the process in the first embodiment shown in FIG. 5.

In FIG. 8, after the candidates of the layout position have been extracted in the case where the regulator is divided into a plurality of regulators and arranged, the regulators are tentatively arranged at the layout position candidates, and the total area of the regulators and the power line in the case where the regulators are arranged at the respective layout position candidates is obtained.

FIG. 8 shows an example in which the regulator is divided into two regulators and arranged with respect three layout position candidates 51-1 to 51-3. In this case, there are considered three kinds of layout combinations consisting of the layout position candidates 51-1 and 51-2, the layout position candidates 51-2 and 51-3, and the layout position candidates 51-1 and 51-3.

In the method of the second embodiment, the total of the area of the power line and the area of the regulators is obtained and compared with respect to the respective chips 50a, 50b and 50c where the regulators are tentatively arranged in the respective layout manners. Then, the regulator layout is decided to the chip where the area is the smallest. In the case of FIG. 8, since the chip 50c in which the regulators 52 and 53 are arranged at the layout position candidates 51-1 and 51-3 is the smallest in the area, the layout positions of the regulators 52 and 53 are set to the layout position candidates 51-1 and 51-3.

In the above-mentioned example, a case in which the regulator is divided into two regulators is exemplified. However, the regulator may be divided into three regulators and arranged. In the case where there are n layout position candidates, the total of the layout area of the regulator and the layout area of the power line is obtained in all of the combinations of the layout positions with respect to the respective layouts of a case in which one regulator is arranged, a case in which two regulators are arranged, . . . a case in which n regulators are arranged. Then, the layout in which the area is the smallest is selected.

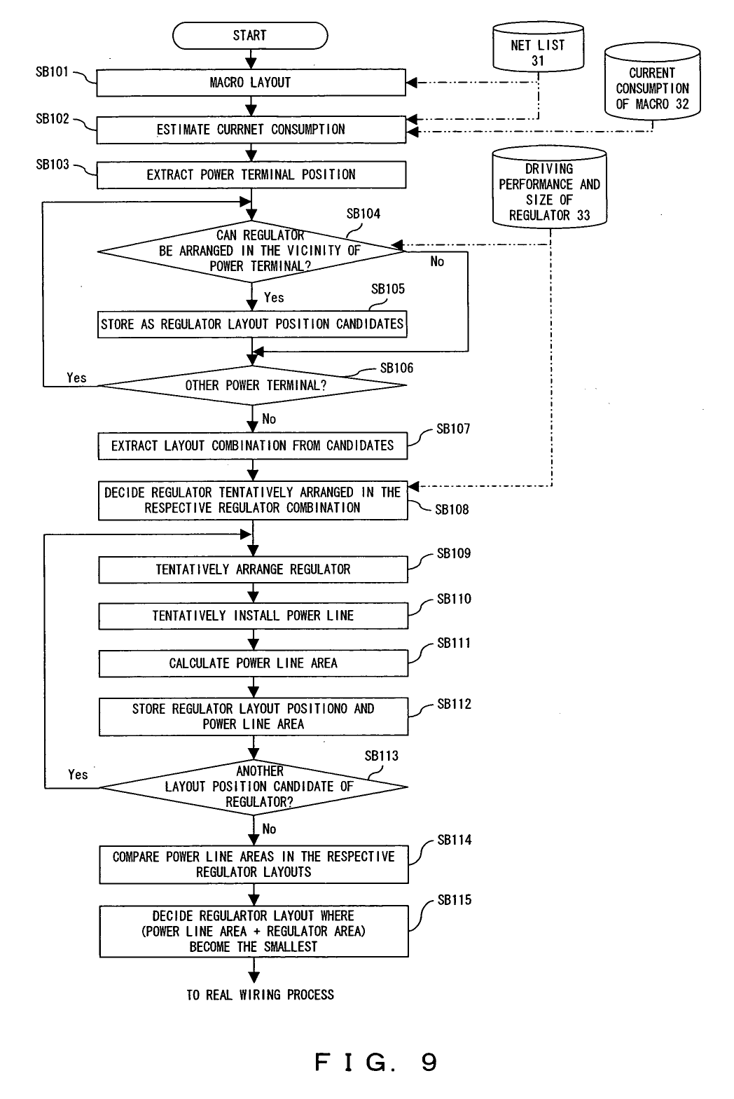

FIG. 9 is a flowchart showing a process that is conducted by the designing device of the second embodiment at the time of designing the layout.

In the figure, when a layout designing process starts, the designing device first arranges the hard macros in Step SB101, and then obtains the current consumptions of the respective hard macros and the total current consumption thereof according to the net list 31 and the hard macro current consumption information 32 which are stored in advance in Step SB102. Then, the designing device obtains the required performance of the regulator on the basis of the power consumption thus obtained.

Then, the designing device extracts the positions of the power terminals as a process of extracting the regulator layout position candidates in Step SB103. The designing device then selects one of the power terminals that have been extracted in Step SB103. Then, the designing device judges whether the regulator having the performance obtained in Step SB103 can be arranged in the vicinity of the selected power terminal on the basis of the driving performance and size of the regulator which is stored in the memory of the designing device in advance. As a result, if the regulator can be arranged (Yes in Step SB104), the designing device stores a position that is in the vicinity of the selected power terminal as the regulator layout position candidate in the memory in Step SB105. On the contrary, if the regulator cannot be arranged in Step SB104 (No in Step SB104), the processing is shifted to Step SB106.

In Step SB106, the designing device judges whether there is a power terminal that is not subjected to the judgment of Step SA104 among the power terminals that have been extracted in Step SA103, or not. If there is a power terminal that has not yet been subjected to the judgment (Yes in Step SA106), the processing is shifted to Step SA104. Thereafter, the processing of Steps SA104 to SA106 is repeated, and conducted on all of the power terminals that have been extracted in Step SA103. After the processing has been conducted on all of the terminals (No in Step SA106), the processing is shifted to Step SA107.

The processes of Steps SB101 to SB106 are substantially identical with those in Steps SA101 to SA106 in the case of the first embodiment shown in FIG. 6.

Upon completion of the extraction of the regulator layout position candidates, the designing device then extracts the combination of the layout positions from the layout position candidates that are stored in Step SB105 in Step SB107, and decides the regulators that are tentatively arranged at the respective layout positions, and stores the regulators thus decided in the memory.

The above combination may be obtained in such a manner that the number of divided and arranged regulators is predetermined, and all of the layouts constituted by the regulators of that number are obtained. Also, the above combination may be obtained in such a manner that the number of divided and arranged regulators is determined on the basis of the number of the obtained layout position candidates, and all of the combinations of the layouts constituted by the regulators of that number are obtained. Further, the above combination may be obtained in such a manner that all of the combinations of all the layouts that are considered in the case where the number of the obtained layout position candidates is equal to or less than the regulators are arranged at the obtained layout position candidates are obtained. As the regulator that is tentatively arranged, a regulator having appropriate driving performance and size is selected taking the area of the layout position candidate and the hard macro to be used into consideration.

When the combination of the regulator layout positions has been extracted, the designing device then obtains the area in the case where the regulators are arranged at the respective layout positions on the basis of the combination thus extracted.

The designing device tentatively arranges in Step SB109 the regulators at the layout positions which are one of the combinations of the layouts that are stored in Step SB108, and then tentatively lays out the power line at that tentative layout in Step SB110.

The designing device calculates in Step SB111 the areas of the regulators that are tentatively arranged in Step SB110 and the power line that is tentatively laid out, and in Step SB112 stores the positions of the tentative layouts of the regulators and the total of the areas of the regulators and the power line at those positions in the memory.

The processes of Steps SB109 to SB112 are conducted on all of the combination of the layouts of the regulators which are stored in Step SB108 (Yes in Step SB113). If the processes of Steps SB109 to SB112 are conducted on all of the combinations of the layouts, and the wiring area of the power line in the case where the regulators are tentatively located is stored (No in Step SB113), the total of the areas of the regulators and the power line is compared in Step SB114 in the combinations of the respective layouts which are stored in Step SB112. The combination of the layout positions at which the area becomes the smallest is decided as the regulator layout position in Step SB115, and the processing is shifted to a real wiring process.

As described above, in the second embodiment, since the regulators can be arranged at the layout positions at which the area required for the power line becomes the smallest, the chip area per se can be suppressed to be small. Also, since a case in which the regulator is divided into a plurality of regulators and arranged is taken into consideration, the chip area can be more reduced than that in the first embodiment.

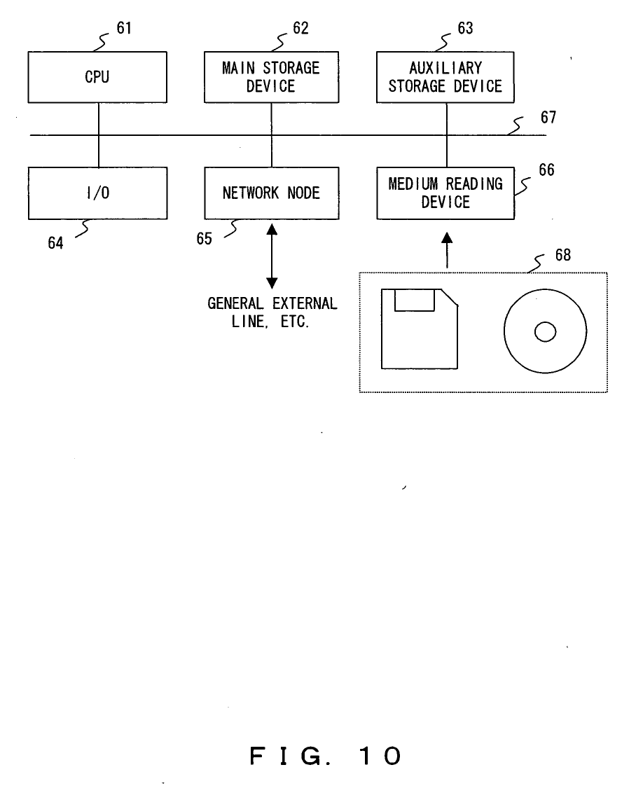

FIG. 10 is a diagram showing a structural example of a designing device that designs a layout of a semiconductor circuit.

The designing device according to this embodiment can be constituted as a dedicated hardware device, or can be realized by executing program on an information processor.

In this example, the designing device includes a CPU 61, a main storage device 62, an auxiliary storage device 63 such as a hard disk, an input/output device (I/O) 64 such as a display or a keyboard, a network node 65 such as a modem, and a medium reading device 66 that reads the stored contents from a portable storage medium such as a disk or a magnetic tape, as shown in FIG. 10. Those elements of the designing device are connected to each other through a bus 67.

In the designing device shown in FIG. 10, program and data which are stored in a storage medium 68 such as a magnetic tape, a flexible disk, a CD-ROM or an MO are read by the medium reading device 66, and then downloaded to the main storage device 62 or the auxiliary storage device 63. Then, the CPU 61 displays a layout design screen on a display device, decides the layout position of a circuit that constitutes a device such as a hard macro or a soft micro, decides the layout position of the regulator as described above, and lays out the power line and the signal line by using information on the net list or the hard macro on the main storage device 62 or the auxiliary storage device 63, or information on the regulators, on the basis of the program or data thus downloaded.

In the designing device shown in FIG. 10, application software may be replaced by another one by using the storage medium 68 such as the flexible disk or the CD-ROM. Accordingly, the present invention is not limited to the designing device or the layout designing method. For example, the present invention can be constituted as the computer readable storage medium 68 for allowing the above-mentioned functions according to the embodiments of the present invention to be executed by a computer when the computer is used.

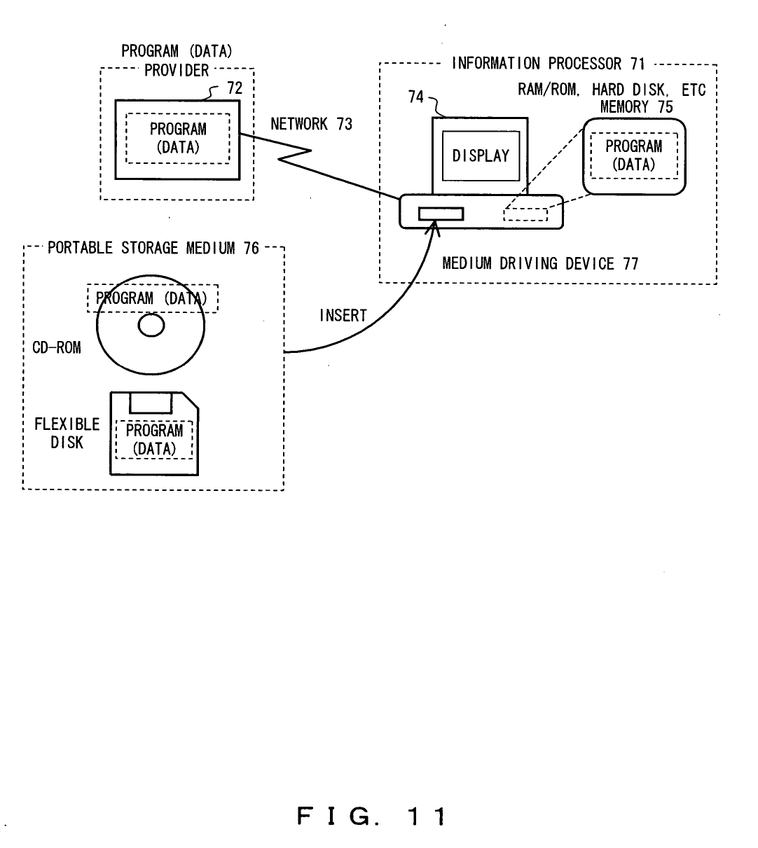

In this example, the storage medium includes, for example, as shown in FIG. 11, a portable storage medium 76 that is detachably attached to a medium driver 77 such as a CD-ROM or a flexible disk (or an MO, a DVD or a removable hard disk), a storage section (data base, etc.) 72 within an external device (server, etc.) which is transmitted through a network line 73, or a memory (RAM, hard disk, etc.) 75 within a main body 74 of an information processor 71. Program that is stored in the portable storage medium 76 or the storage section (data base, etc.) 72 is downloaded to the memory (RAM, hard disk, etc.) 75 within the main body 74 and then executed.

Also, as the storage medium such as the CD-ROM or the DVD-ROM as was described above, in addition to the above storage mediums, various high-capacity storage mediums that will be developed in the future can be used to implement the present invention. The various high-capacity storage mediums may be, for example, a next-generation optical disk storage medium using a blue diode such as a blu-ray disc (registered trademark) or an AOD (advanced optical disc), an HD-DVD9 using a red laser, or a blue laser DVD using a violet-blue laser.

In the above examples, the designing device according to this embodiment decides the regulator layout position according to any method of the first embodiment and the second embodiment. However, the designing device according to this embodiment may obtain the area according to both the methods of the first embodiment and the second embodiment, and adopt the layout at which the area becomes the smallest. Alternatively, in the case where the area at the layout according to the second embodiment is smaller than the area at the layout according to the first embodiment, the regulator may be divided and arranged.

Also, in the above second embodiment, when the regulator is divided into a plurality of regulators, the regulator is divided into the regulators having the same size. However, the plurality of divided regulators may be different in the size or performance from each other.

The foregoing description of the preferred embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principles of the invention and its practical application to enable one skilled in the art to utilize the invention in various embodiments and with various modifications as are suited to the particular use contemplated. It is intended that the scope of the invention be defined by the claims appended hereto, and their equivalents.

What is claimed is:

1. A designing device for designing a layout of a semiconductor device, comprising:
a layout position candidate extracting unit for obtaining layout position candidates of a regulator;
a tentatively wiring unit for tentatively arranging the regulator at the layout position candidates and tentatively laying out a power line; and
a regulator layout position deciding unit for deciding a position of a tentative layout at which an area of the power line that is tentatively laid out is the smallest as the layout position of the regulator.

2. A designing device for designing a layout of a semiconductor device, comprising:
a layout position candidate extracting unit for obtaining layout position candidates of regulators;
a tentatively wiring unit for tentatively arranging a plurality of regulators at the layout position candidates and tentatively laying out a power line; and
a regulator layout position deciding unit for deciding a position of a tentative layout at which an area of the power line that is tentatively laid out is the smallest as the layout position of the regulators.

3. A semiconductor device, comprising:
a power terminal;
a circuit block that is subjected to layout design by a hard macro; and
a regulator that is located in the vicinity of the power terminal and the circuit block.

4. The semiconductor device according to claim 3, further comprising a power line that is wider between the circuit block and the regulator and narrower far from the circuit block and the regulator.

5. A layout designing method for a semiconductor device, comprising:
obtaining layout position candidates of a regulator;
tentatively arranging the regulator at the layout position candidates, then tentatively laying out a power line, and obtaining an area of the power line when the regulator is tentatively arranged at the respective layout position candidates; and
arranging the regulator at a tentative layout position at which an area of the power line that is tentatively laid out is the smallest.

6. The layout designing method according to claim 8, wherein after the regulator is divided and tentatively arranged at the layout position candidates, the power line is tentatively laid out, and the area of the power line when the regulators are tentatively arranged at the respective layout position candidates is obtained, and
wherein the regulator is divided and arranged when the smallest total of the area of the power line that is tentatively laid out and the areas of the divided regulators after the regulator is divided and tentatively arranged is smaller than the smallest total of the area of the power line and the regulator that are tentatively laid out after the regulator is not divided and is tentatively arranged.

7. A layout designing method for a semiconductor device, comprising:
obtaining layout position candidates of regulators;
tentatively arranging a plurality of regulators at the layout position candidates, and then tentatively laying out a power line; and
arranging the regulators at the tentative layout positions at which the total of the areas of the power line that is tentatively laid out and the plurality of regulators is the smallest.

8. The layout designing method according to claim 10, wherein the respective totals of the areas are obtained when one or more regulators are arranged at the layout position candidates, and the regulators are arranged at the tentative layout positions at which the total of the areas becomes the smallest.

9. The layout designing method according to claim 11, wherein the combination of the layout position candidates in the case where one or more regulators are arranged at the layout position candidates is obtained, and
wherein the total of the area in the case where the regulators are tentatively arranged by the combination of the respective layout position candidates is obtained, and the regulators are arranged at the tentative layout position at which the total of the areas becomes the smallest.

10. The layout designing method according to claim 8, wherein the layout position candidates of the regulator are obtained in the vicinity of a power terminal of the semiconductor device.

11. The layout designing method according to claim 8, wherein a circuit block made up of a hard macro is arranged, and
wherein the regulator is arranged at the tentative layout position at which an area of the power line that is tentatively laid out between the hard macro and the regulator is the smallest.

12. The layout designing method according to claim 8, wherein a circuit block made up of a hard macro is arranged, and
wherein a wider power line is laid out between the regulator and the circuit block, and a narrower power line is laid out far from the regulator and the circuit block.

13. The layout designing method according to claim 8, wherein the regulator comprises a step-up circuit for stepping up an external voltage to convert the external voltage into an internal voltage.

14. The layout designing method according to claim 8, wherein the regulator comprises a step-down circuit for stepping down an external voltage to convert the external voltage into an internal voltage.

15. A portable storage medium storing a program used in a computer to perform:
obtaining layout position candidates of a regulator;
tentatively arranging the regulator at the layout position candidates, then tentatively laying out a power line, and obtaining an area of the power line when the regulator is tentatively arranged at the respective layout position candidates; and
arranging the regulator at a tentative layout position at which an area of the power line that is tentatively laid out is the smallest.

16. A portable storage medium storing a program used in a computer to perform:
obtaining layout position candidates of regulators;
tentatively arranging a plurality of regulators at the layout position candidates, and then tentatively laying out a power line; and
arranging the regulators at the tentative layout positions at which the total of the areas of the power line that is tentatively laid out and the plurality of regulators is the smallest.
